(19) United States
(12) Patent Application Publication
(10) Pub. No.: US 2016/0209641 A1
(43) Pub. Date: Jul. 21, 2016

(54) LIGHT MODULATORS INCORPORATING MULTIPLE INTEGRATED LOW-CAPACITANCE INTERCONNECTS

(71) Applicant: Pixtronix, Inc., San Diego, CA (US)

(72) Inventors: Michael Andrew Gingras, Somerville, MA (US); Javier Villarreal, Somerville, MA (US); Mark Bradford Andersson, Northborough, MA (US); Joyce Wu, Somerville, MA (US); Hung-Chien Lin, Hsinchu (TW); Chin-Yuan Ho, Hsinchu (TW)

(21) Appl. No.: 14/599,047

(22) Filed: Jan. 16, 2015

(51) Int. Cl. G02B 26/02; G09G 3/34

(52) U.S. Cl. CPC G02B 26/02; G09G 3/3433

(57) ABSTRACT

This disclosure provides systems, methods and apparatus for reducing capacitance between interconnects in a display apparatus. In one aspect, a display apparatus can include a plurality of light modulators each having a shutter suspended over a substrate. A first suspended interconnect can electrically couple a first light modulator and a second light modulator. A majority of the length of the first suspended interconnect can be suspended a first height above the substrate. A second suspended interconnect can electrically couple the first light modulator and a third light modulator. A majority of the length of the second suspended interconnect can be above the substrate at a different height than the first suspended interconnect.

### TECHNICAL FIELD

This disclosure relates to the field of imaging displays, and to light modulators incorporated into imaging displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or a combination of these or other micromachining processes that etch away parts of substrates, the deposited material layers, or both. Such processes may also be used to add layers to form electrical and electromechanical devices.

EMS-based display apparatus can include display elements that modulate light by selectively moving a light blocking component into and out of an optical path through an aperture defined through a light blocking layer. Capacitance between circuit layers in a display apparatus can be detrimental to the power profile and performance of a display. Increased capacitance can require higher drive voltages and decreased signal propagation rates.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display including a substrate and a plurality of light modulators, each including a shutter suspended over the substrate. The display includes a first suspended interconnect electrically coupling a first light modulator and a second light modulator of the plurality of light modulators. More than 50% of a length of the first suspended interconnect is suspended at a first height over the substrate. The display includes a second suspended interconnect electrically coupling the first light modulator to a third light modulator of the plurality of light modulators. More than 50% of a length of the second suspended interconnect is suspended at a second height, different from the first height, over the substrate.

In some implementations, the first height is greater than the second height to allow the first suspended interconnect to pass over the second suspended interconnect. In some implementations, the display includes an elevated aperture layer (EAL) suspended over the plurality of light modulators. An uppermost surface of the first suspended interconnect can be substantially coplanar with an uppermost surface of the elevated aperture layer. In some implementations, an uppermost surface of the second suspended interconnect can be substantially coplanar with an uppermost surface of at least one light modulator shutter. In some implementations, the first suspended interconnect couples to anchors associated with the first and second light modulators.

In some implementations, each of the first and second suspended interconnects includes at least one of a structural layer, a conductive layer, a protective layer, and a passivation layer. In some implementations, the structural layer for at least one of the first and second suspended interconnects includes amorphous silicon (a-Si). In some implementations, the conductive layer for at least one of the first and second suspended interconnects includes an opaque metal. In some implementations, the first suspended interconnect serves as a data line for the display and the second suspended interconnect serves as a scan line for the display. In some implementations, a first portion of the first suspended interconnect is oriented substantially parallel to the display and a second portion of the first suspended interconnect is oriented substantially perpendicular to the display. In some implementations, a length of the first suspended interconnect is substantially perpendicular to a length of the second suspended interconnect. In some implementations, the first height of the first suspended interconnect and the second height of the second suspended interconnect reduce the capacitance between the respective suspended interconnects a backplane on the substrate.

In some implementations, the display includes a processor capable of communicating with the display. The processor can be capable of processing image data. The display also can include a memory device capable of communicating with the processor. In some implementations, the display can include a driver circuit capable of sending at least one signal to the display and a controller capable of sending at least a portion of the image data to the driver circuit. In some implementations, the display can include an image source module capable of sending the image data to the processor. The image source module can include at least one of a receiver, transceiver, and transmitter. In some implementations, the display can include an input device capable of receiving input data and communicating the input data to the processor.

Another innovative aspect of the subject matter described in this disclosure can be implemented in a method of forming a display apparatus. The method includes forming a first mold portion on a substrate. The method includes depositing a first layer of structural material over the first mold portion. The method includes patterning the first layer of structural material to define a plurality of MEMS light modulators and a first suspended interconnect. The method includes forming a second mold portion over the patterned first layer of structural material. The method includes depositing a second layer of structural material over the second mold portion. The method includes patterning the second layer of structural material to define a second suspended interconnect.

In some implementations, the method can include patterning the second layer of structural material to define an elevated aperture layer. In some implementations, the first layer of structural material can include a conductive material and the method can include depositing a layer of protective material over the conductive material. In some implementations, the method can include coating the exposed surfaces of the plurality of light modulators, the first suspended interconnect, and the second suspended interconnect with a passivation material. In some implementations, a length of the first suspended interconnect can be substantially perpendicular to a length of the second suspended interconnect.

Another innovative aspect of the subject matter described in this disclosure can be implemented in a display including a substrate and a plurality of light modulators. Each light modulator can include including a shutter suspended over the substrate. A first suspended interconnect electrically couples a first light modulator and a second light modulator of the plurality of light modulators. At least a portion of a length of the first suspended interconnect between the first light modulator and the second light modulator is suspended at a first height over the substrate. A second suspended interconnect electrically couples the first light modulator to a third light modulator of the plurality of light modulators. At least a portion of a length of the second suspended interconnect between the first light modulator and the third light modulator is suspended at a second height over the substrate. The first height is greater than the second height to allow the first suspended interconnect to pass over the second suspended interconnect.

In some implementations, the display includes an elevated aperture layer suspended over the plurality of light modulators. An uppermost surface of the first suspended interconnect can be substantially coplanar with an uppermost surface of the elevated aperture layer. In some implementations, an uppermost surface of the second suspended interconnect can be substantially coplanar with an uppermost surface of at least one light modulator shutter. In some implementations, the first suspended interconnect couples to anchors associated with the first and second light modulators.

In some implementations, each of the first and second suspended interconnects includes at least one of a structural layer, a conductive layer, a protective layer, and a passivation layer. In some implementations, the structural layer for each of the first and second suspended interconnects is formed from amorphous silicon (a-Si). In some implementations, the conductive layer for each of the first and second suspended interconnects is formed from an opaque metal. In some implementations, the first suspended interconnect serves as a data line for the display and the second suspended interconnect serves as a scan line for the display. In some implementations, a first portion of the first suspended interconnect is oriented substantially parallel to the display and a second portion of the first suspended interconnect is oriented substantially perpendicular to the display.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3A shows a top view of a portion of an example display device incorporating suspended interconnects.

FIG. 3B shows a first cross-sectional view of a first example implementation of the display device shown in FIG. 3A.

FIG. 3C shows a second cross-sectional view of the first example implementation of the display device shown in FIG. 3A.

FIG. 3D shows a first cross-sectional view of a second example implementation of the display device shown in FIG. 3A.

FIG. 3E shows a second cross-sectional view of the second example implementation of the display device shown in FIG. 3A.

FIG. 3F shows a third cross-sectional view of the second example implementation of the display device shown in FIG. 3A.

FIG. 3G shows a fourth cross-sectional view of the second example implementation of the display device shown in FIG. 3A.

FIG. 4 shows a flow diagram of an example process for manufacturing a display device including suspended interconnects.

FIGS. 5A-5R show cross sectional views of example stages of construction of an example display apparatus according to the manufacturing process shown in FIG. 4.

FIGS. 6A and 6B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A low-capacitance backplane for a MEMS display device can be fabricated to include certain interconnects suspended over the substrate on which the backplane and MEMS components, such as light modulators, are built. These interconnects can be referred to as “suspended interconnects.” In some implementations, a backplane for a MEMS display device may include multiple levels of suspended interconnects. For example, a first suspended interconnect can be fabricated to have a majority of its length suspended at a first height above the substrate. In some implementations, the first height can be substantially the same height as the shutters of the light modulators of the display. A second suspended interconnect can be fabricated to have a majority of its length suspended at a second height above the substrate. The second height can be different from the first height, so that the first and second suspended interconnects can cross each other without being electrically connected. The suspended interconnects can each couple to several of the light modulators. For example, the suspended interconnects can serve as data lines or scan lines for the display, and can carry voltages to the display elements to which they are connected.

Particular implementations of the subject matter described in this disclosure can be implemented to realize one or more of the following potential advantages. By incorporating interconnects that are suspended at different heights within the display apparatus, the capacitance between the interconnects can be reduced. For example, the separation distance between the interconnects can be increased because the interconnects are not all positioned within the layered stack of materials that form a conventional backplane of the display apparatus, and the increased separation distance can lead to a reduced capacitance. As a result, signals can be transmitted through such interconnects with a higher signal propagation rate at a lower power and therefore the display may operate with reduced power consumption, lower drive voltages, or both. Suspended interconnects also can exhibit lower electrical resistance than conventional interconnects. For example, a suspended interconnect can be made from a layer of metal having a larger cross-sectional area than interconnects formed within a conventional backplane. The greater cross-sectional area can result in lower electrical resistance, which can allow a display device incorporating the suspended electrical interconnects to be operated with less power than a display device incorporating conventional electrical interconnects.

Because the interconnects can be suspended at different heights, they also can bridge one another while remaining electrically isolated from one another. This allows for suspending more interconnects over the substrate, allowing further capacitance reduction. In some implementations, the interconnects can be formed from the same materials and during the same processing stages as the components of the display elements, thereby reducing the number of processing steps needed to form the interconnects.

Incorporating suspended interconnects also can allow for smaller display elements. Circuit components, including interconnects, can account for a significant percentage of the surface area of each display element in a display. Elevating the interconnects so that they are suspended above the substrate creates more space for other circuit elements, such as transistors, to be formed in one or more layers over an underlying substrate. Therefore, display elements having suspended interconnects can occupy less space than display elements whose interconnects are formed in the layers on the underlying substrate. The reduced size of each display element can allow for displays having an increased display element density and an increased aperture ratio.

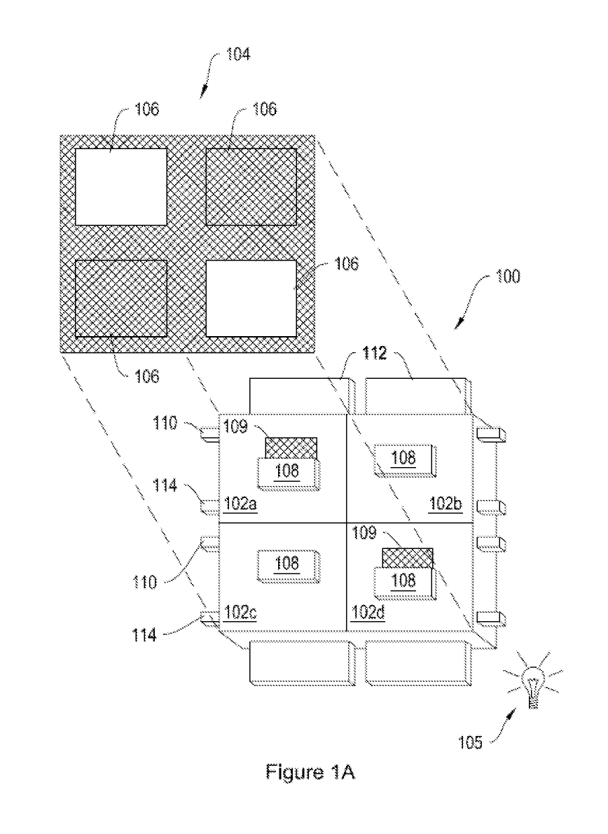

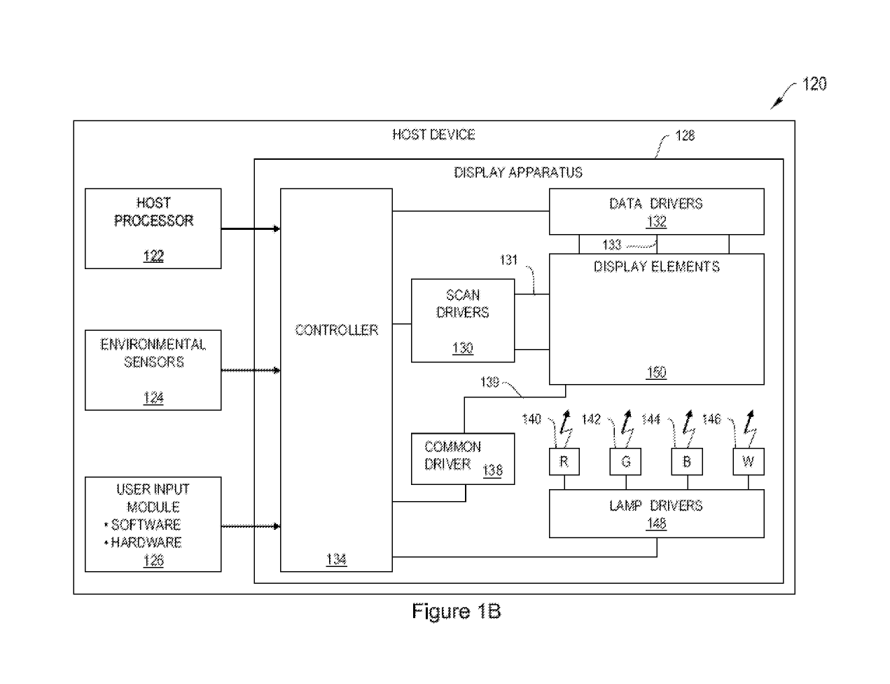

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness of the display, the contrast of the display, or both.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; instructions for the display apparatus 128 for use in selecting an imaging mode; or any combination of these types of information.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

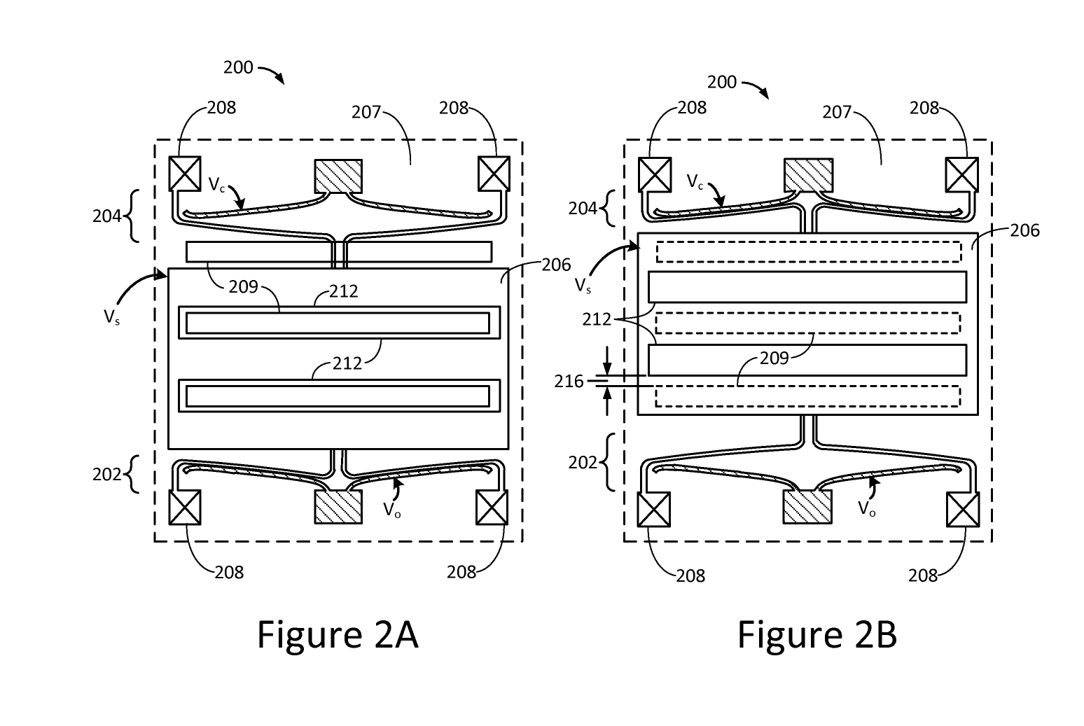

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

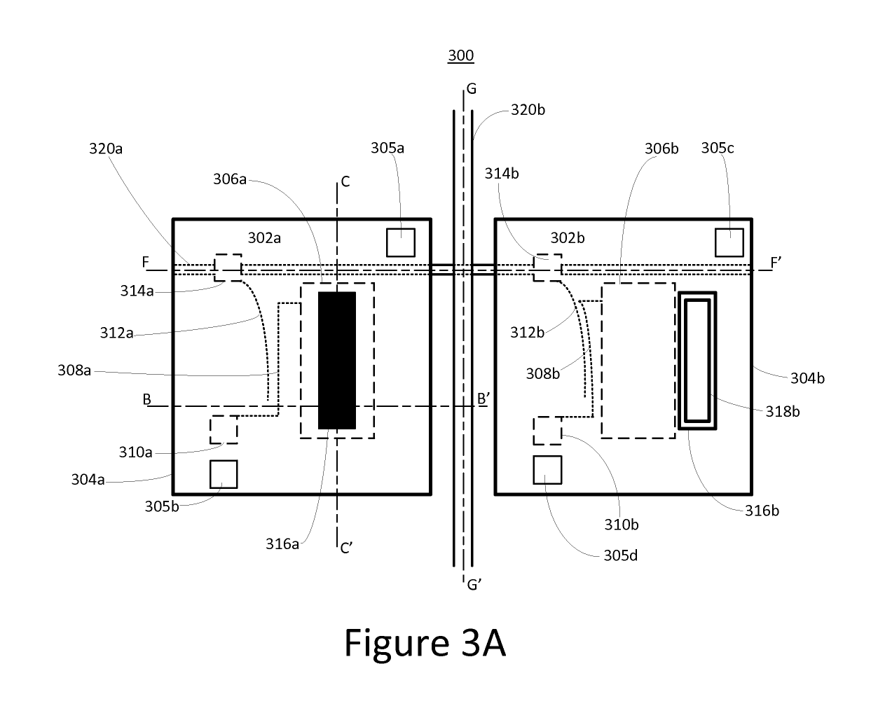

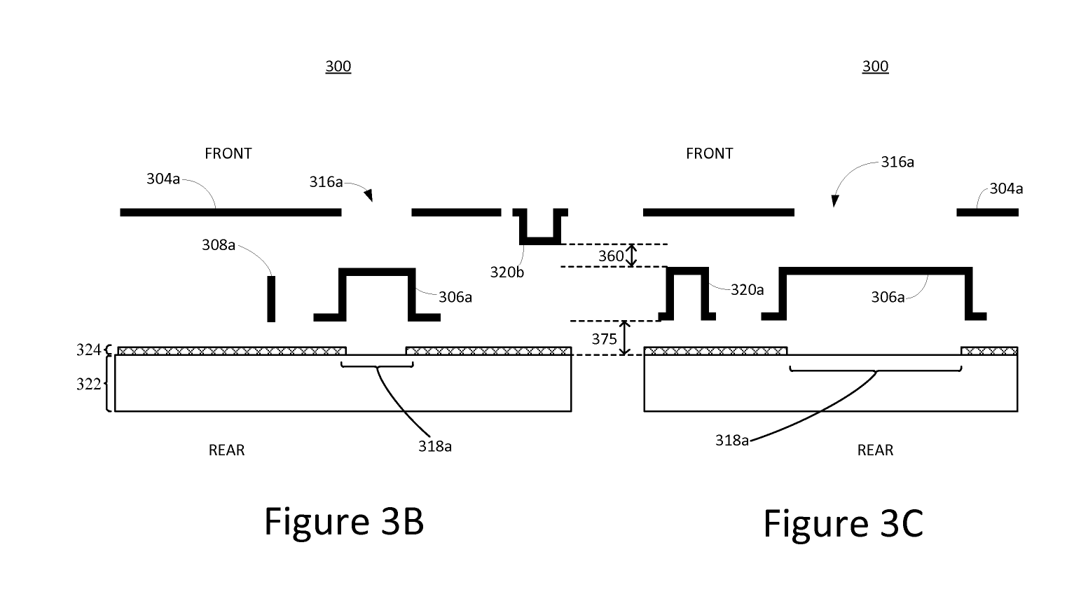

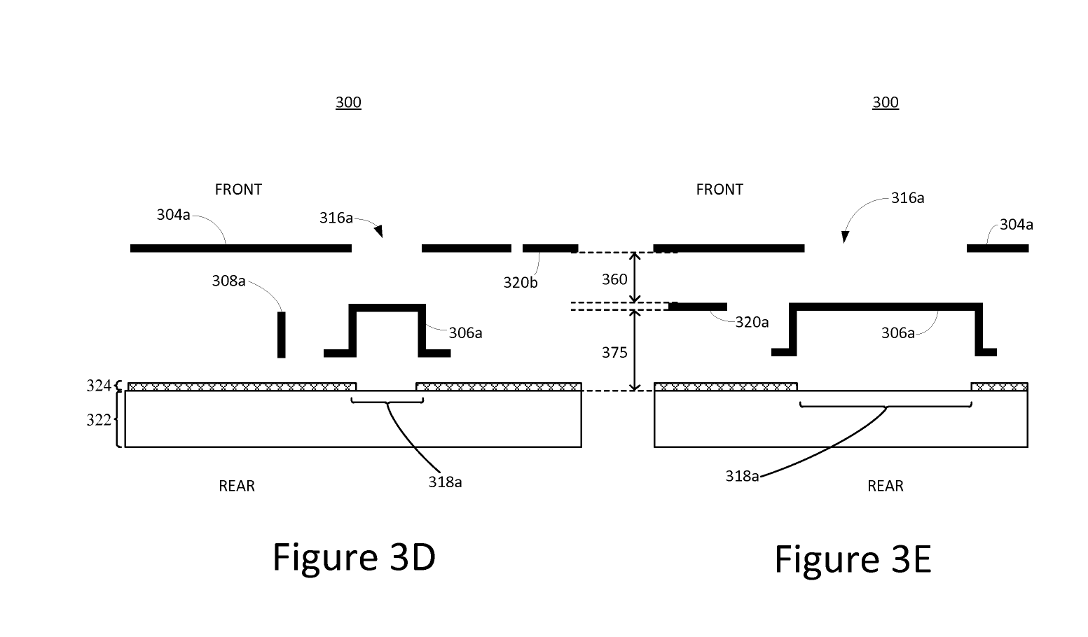

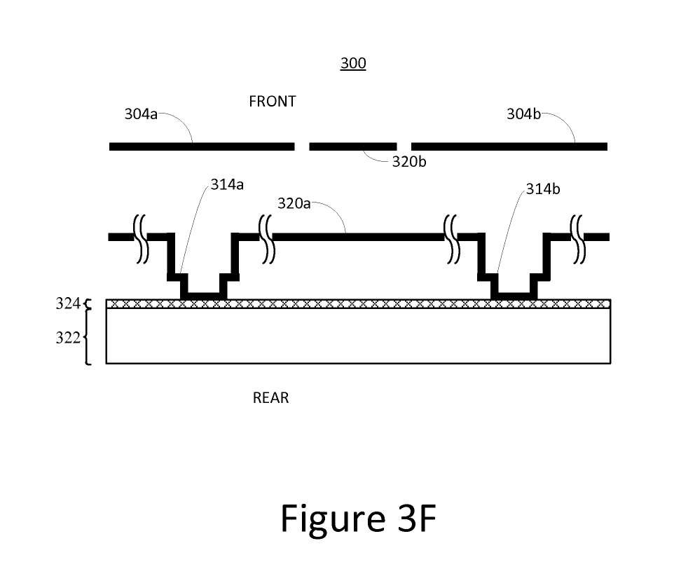

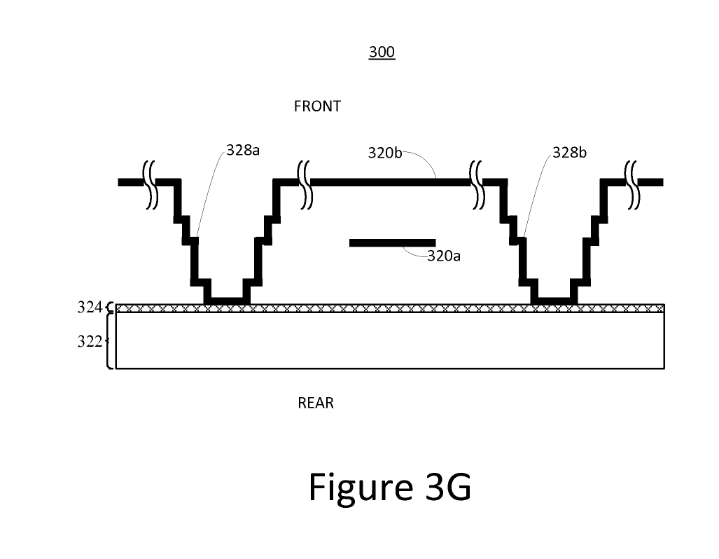

FIG. 3A shows a top view of a portion of an example display device 300 incorporating suspended interconnects 320a and 320b. The portion of the display device 300 shown in FIG. 3A includes two display elements 302a and 302b (generally referred to as display elements 302). The display element 302a includes an elevated aperture layer (EAL) 304a positioned above a rear substrate. The EAL 304a is supported by EAL anchors 305a and 305b. In the top down view of FIG. 3A, the EAL 304a obscures the view of the components beneath it. Therefore the components below the EAL 304a are shown in broken lines.

The display element 302a includes a shutter 306a. One end of a load electrode 308a couples to an edge of the shutter 306a, and another end of the load electrode 308a couples to a load electrode anchor 310a. The shutter 306a is suspended between the rear substrate and the EAL 304a by the load electrode 308a. A drive electrode 312a is positioned adjacent to the load electrode 308a and couples at one end to a drive electrode anchor 314a. The load electrode 308a and the drive electrode 312a together form an actuator for moving the shutter 306a laterally across the display element 302a.

The position of the shutter 306a is controlled by the actuator. For example, an actuation voltage can be applied across the drive electrode 312a and the load electrode 308a of the actuator. The actuation voltage creates an electrostatic force that tends to draw the drive electrode 312a and the load electrode 308a together. Because the drive electrode 312a is fixed at one end to the substrate by the anchor 314a, the electrostatic force causes the load electrode 308a to move towards the drive electrode 312a. As the load electrode 308a moves, the shutter 306a also moves toward the drive electrode 312a while remaining substantially parallel to the underlying substrate and the EAL 304a, because the load electrode 308a is coupled to the edge of the shutter 306a. The shutter 306a can be controlled to move in the opposite direction (i.e., towards the right-hand side of FIG. 3A) by removing the actuation voltage. In some implementations, a second actuator can couple to the opposite side of the shutter 306a to actively pull the shutter 306a in the opposite direction. Therefore, by selectively applying actuation voltages to the actuator(s), the position of the shutter 306a can be controlled.

The EAL 304a includes an aperture 316a aligned with a rear aperture 318a formed in a light blocking layer on the rear substrate. In FIG. 3A, the rear aperture 318a of the display element 302a is obscured by the shutter 306a and thus is not shown in FIG. 3A, but can be seen in FIGS. 3B-3E. The display device 300 includes a backlight positioned behind the rear substrate. The backlight can emit light towards the EAL 304a. When the shutter 306a is aligned with the EAL aperture 316a, it prevents light from escaping from the display light through the EAL aperture 316a, as shown in the display element 302a. When the shutter is actuated out of the optical path between the EAL aperture 316a and the corresponding rear aperture 318a, light is permitted to pass out of the display. Thus, by modulating the position of the shutter 306a using the load electrode 308a and the drive electrode 312a, the amount of light that is permitted to escape from the display element 302a can be controlled. This light can represent a single pixel of an image on the display device 300. While two display elements 302 are shown in FIG. 3A, the display device 300 may include many thousands of light modulators similar to the display elements 302, in order to form a full image.

The display element 302b includes components similar to those described above in connection with the display element 302a. Like reference numerals refer to like elements. For example, the display element 302b includes an EAL 304b supported above a rear substrate by EAL anchors 305c and 305d. The EAL 304b includes an EAL aperture 316b. In some implementations, the EAL 304a and the EAL 304b can be formed from a single layer or multiple layers of structural material through which the EAL apertures 316a and 316b are formed. A shutter 306b is suspended above the rear substrate by a load electrode 308b, which couples to a load electrode anchor 310b. A drive electrode 312b couples to a drive electrode anchor 314b. In FIG. 3A, the shutter 306b is shown in an actuated position in which it does not obstruct the EAL aperture 316b or its corresponding rear aperture 318b formed in the light blocking layer on the rear substrate.

The display device 300 includes a first suspended interconnect 320a and a second suspended interconnect 320b. The first suspended interconnect 320a is arranged substantially perpendicular to the second suspended interconnect 320b. The first suspended interconnect 320a is positioned at a first height over the rear substrate. In some implementations, an upper surface of the first suspended interconnect 320a is at a lower height over the substrate than a lower surface of the second suspended interconnect 320b, so that the second suspended interconnect 320b passes over the first suspended interconnect 320a. Only portions of the first and second suspended interconnects 320a and 320b are shown in FIG. 3A.

In some implementations, the first suspended interconnect 320a may extend along substantially the entire length of the display device 300. As shown, the first suspended interconnect 320a electrically couples the drive electrode anchor 314a of the first display element 302a to the drive electrode anchor 314b of the second display element 302b. In some implementations, the first suspended interconnect 320a can couple to different or additional components of the display device 300. For example, the first suspended interconnect 320a may electrically couple to all of the display elements in the same row or column as the first display element 302a and the second display element 302b. In some other implementations, the first suspended interconnect 320a may couple to a subset of the display elements in the same row or column as the first display element 302a and the second display element 302b. In some implementations, the first suspended interconnect 320a can couple, through an anchor, to a terminal (a source/drain terminal or gate terminal) of one or more transistors associated with one or more display elements 302.

In some implementations, the first suspended interconnect 320a can serve as a data line (similar to the data lines 132 shown in FIG. 1B) for the display device 300 by transmitting voltages corresponding to image data to one or more of the display elements 302. In some other implementations, the first suspended interconnect 320a can serve as a scan line (similar to the scan lines 131 shown in FIG. 1B) for the display device 300. For example, the first suspended interconnect can couple to the gate terminals of write enabling transistors coupled to each display element. A voltage can be applied to the write enabling transistor gate via the first suspended interconnect 320a in order to allow the transistor to load a voltage associated with image data applied at one of its source/drain terminals. In some other implementations, the first suspended interconnect 320a can serve as a common interconnect, such as the common interconnect 139 shown in FIG. 1B.

The first display element 302a is separated from the second display element 302b by the second suspended interconnect 320b. The second suspended interconnect 320b is positioned at a second height over the rear substrate. In some implementations, an upper surface of the second suspended interconnect 320b is substantially coplanar with an upper surface of the EAL 304a and the EAL 304b. In practice, the second suspended interconnect 320b may extend along substantially the entire length of the display device 300. The second suspended interconnect 320b can serve to electrically couple various components of the display device 300. For example, the second suspended interconnect 320b may electrically couple to one or more of the display elements 302 in the display device 300. Like the first suspended interconnect 320a, the second suspended interconnect 320b can serve as a data line 132 or a scan line 131 for the display device 300. In some other implementations, the second suspended interconnect 320b can serve as a common interconnect 139.

FIG. 3B shows a first cross-sectional view of a first example implementation of the display device 300 shown in FIG. 3A. The cross-section shown in FIG. 3B is taken along the line B-B′ shown in FIG. 3A. FIG. 3C shows a second cross-sectional view of the first example implementation of the display device 300 shown in FIG. 3A. The cross-section shown in FIG. 3C is taken along the line C-C′ shown in FIG. 3A. FIG. 3B and FIG. 3C are discussed together below.

As can be seen in the cross-sectional views of FIGS. 3B and 3C, the display device 300 includes a rear substrate 322. A light blocking layer 324 is formed over the rear substrate 322. A rear aperture 318a is formed through the light blocking layer and aligned with the EAL aperture 316a. As described above, the shutter 306a moves laterally (i.e., parallel to the rear substrate 322 and the EAL 304a) in response to an actuation voltage. FIGS. 3B and 3C show the shutter 306a in the closed position in which the shutter is positioned to prevent light that originates behind the rear substrate 322 (such as from a backlight) from passing through the EAL aperture 316a.

The second suspended interconnect 320b (shown in FIG. 3B) has a generally U-shaped cross-section and is positioned so that its upper surface is substantially coplanar with the upper surface of the EAL 304a. In some implementations, the second suspended interconnect 320b is formed from the same layer(s) of structural material used to form the EAL 304a. The layer(s) can be patterned and etched to remove a portion of the structural material between the EAL 304a and the second suspended interconnect 320b so that the EAL 304a and the second suspended interconnect 320b are electrically isolated from one another. In addition to serving as an electrical connection within the display 300, the second suspended interconnect 320b can be utilized to block extraneous light from escaping from the display. In some implementations, the size of the gap between the EAL 304a and the second suspended interconnect 320b can be selected to increase the light blocking ability of the second suspended interconnect 320b. For example, the gap can be formed to be relatively narrow, such as between about two microns and about five microns. In some implementations, the EAL 304a and the second suspended interconnect 320b can both be formed from a metal such as aluminum (Al) or titanium (Ti). In some other implementations, the EAL 304a and the second suspended interconnect 320b can be formed from semiconducting material such as amorphous silicon (a-Si). If the second suspended interconnect 320b is formed from a semiconducting material, it can be coated with a metal layer to improve its conductivity and light blocking properties.

The first suspended interconnect 320a (shown in FIG. 3C) also has a generally U-shaped cross-section. It is positioned so that its upper surface is at substantially the same height as an upper surface of the shutter 306a. The first suspended interconnect 320a is suspended above the rear substrate 322 by a separation distance 375. In some implementations, the separation distance 375 can be in the range of about one micron to about five microns. In some implementations, the first suspended interconnect 320a is formed from the same layer(s) of structural material used to form the shutter 306a. The layer(s) of structural material can be patterned and etched to remove a portion of the structural material between the shutter 306a and the first suspended interconnect 320a so that the shutter 306a and the first suspended interconnect 320a are electrically isolated from one another. This allows the shutter 306a to move independently of the first suspended interconnect 320a. The first suspended interconnect 320a has a length that extends substantially parallel to the direction of motion of the shutter 306a. As a result, motion of the shutter 306a does not cause the shutter 306a to contact the first suspended interconnect 320a. Therefore, the distance separating the shutter 306a from the first suspended interconnect 320a can be made small without the risk of the shutter 306a coming into contact with the first suspended interconnect 320a.

In some implementations, the bottom surface of the second suspended interconnect 320b can be higher above the rear substrate 322 than the top surface of the first suspended interconnect 320a. Therefore, the second suspended interconnect 320b can pass directly over the first suspended interconnect 320a while remaining electrically isolated from the first suspended interconnect 320a. In some implementations, the separation distance 360 between the second suspended interconnect 320b and the first suspended interconnect 320a can contribute to a reduction in the capacitance between the second suspended interconnect 320b and the first suspended interconnect 320a, which can lead to improved performance of the display device 300. In some implementations, the separation distance 360 can be between about one micron and five microns. Decreased capacitance can result in higher signal propagation rates and lower operating voltages. The display device 300 can therefore operate with a higher refresh rate, a lower power consumption, or both. Because the second suspended interconnect 320b and the first suspended interconnect 320a are arranged substantially perpendicular, the overlapping area at the intersection of the second suspended interconnect 320b and the first suspended interconnect 320a is relatively small, which also reduces the total capacitance between the second suspended interconnect 320b and the first suspended interconnect 320a.

FIG. 3D shows a first cross-sectional view of a second example implementation of the display device 300 shown in FIG. 3A. The cross-section shown in FIG. 3D is taken along the line B-B′ shown in FIG. 3A. FIG. 3E shows a second cross-sectional view of the second example implementation of the display device 300 shown in FIG. 3A. The cross-section shown in FIG. 3E is taken along the line C-C′ shown in FIG. 3A. Like the first implementation shown in FIGS. 3B and 3C, the second implementation of the example display device 300 shown in FIGS. 3D and 3E includes a rear substrate 322 covered by a light blocking layer 324. A rear aperture 318a is defined through the light blocking layer 324 and aligned with an aperture 316a defined in the EAL 304a. A shutter 306a is suspended above the substrate 322.

The second implementation of the example display device 300 is distinguished from the first implementation by the shape of the first suspended interconnect 320a and the second suspended interconnect 320b. As shown in FIGS. 3D and 3E, both the first suspended interconnect 320a and the second suspended interconnect 320b have substantially planar cross sections, rather than generally U-shaped cross sections as shown in FIGS. 3B and 3C. The first suspended interconnect 320a can be formed from the same layer(s) of structural material used to form the shutter 306a, and can be positioned at the same height as the upper surface of the shutter 306a. The second suspended interconnect 320b can be formed from the same layer(s) of structural material used to form the EAL 304a.

In some implementations, planar suspended interconnects may be used to increase the separation distance 360 without increasing the thickness of the device 300. For example, because the suspended interconnects 320a and 320b shown in FIGS. 3D and 3E are planar, the separation distance 360 between them is greater than the separation distance between the U-shaped suspended interconnects shown in FIGS. 3B and 3C. In some implementations, the separation distance 360 can be further increased by positioning the first suspended interconnect 320a at the same height as the lower edge of the shutter 306a. For example, the separation distance 360 in such an implementation can be in the range of about five microns to about 10 microns.

In some other implementations, one of the first or second suspended interconnect 320a or 320b can have a generally planar cross section while the other suspended interconnect has a generally U-shaped cross sections. In some other implementations, either or both of the first and second suspended interconnects 320a and 320b may have other cross-sectional shapes without departing from the scope of this disclosure. For example, in some implementations, the first and second suspended interconnects 320a and 320b may have square or rectangular cross-sectional shapes. In some other implementations, the first and second suspended interconnects 320a and 320b may have L-, I-, or S-shaped cross-sectional shapes. In still other implementations, any type of cross-sectional shape may be used for the first and second suspended interconnects 320a and 320b.

FIG. 3F shows a third cross-sectional view of the second example implementation of the display device 300 shown in FIG. 3A. The cross-section shown in FIG. 3D is taken along the line F-F′, which runs along the length of the first suspended interconnect 320a. As shown, the first suspended interconnect 320a is positioned at a lower height above the substrate 322 than the second suspended interconnect 320b. This allows the second suspended interconnect 320b to pass over the first suspended interconnect 320a.

The first drive electrode anchor 314a and the second drive electrode anchor 314b are fixed to the rear substrate 322. The first suspended interconnect 320a couples to the first drive electrode anchor 314a and the second drive electrode anchor 314b. Thus, the second suspended interconnect electrically connects the first drive electrode anchor 314a to the second drive electrode anchor 314b. In some implementations, the first suspended interconnect 320a can be configured to carry a voltage corresponding to image data. For example, the first suspended interconnect 320a can distribute an actuation voltage to the drive electrode anchors 314a and 314b to cause the respective shutters 306 to move into an open state or a closed state based on the image data.

In some implementations, there may be additional circuitry formed directly on the rear substrate 322. For example, transistors and other electrical components associated with controlling the state of the display elements included within the display 300 can be formed over the rear substrate 322. In some implementations, these electrical components may be formed from several layers of metal and semiconducting material and intervening dielectric layers. The first suspended interconnect 320a can carry electrical signals to this circuitry, for example, via the drive electrode anchors 314a and 314b.

The first drive electrode anchor 314a and the second drive electrode anchor 314b also provide structural support to the second suspended interconnect by holding it above the substrate. In some implementations, the first suspended interconnect 320a may extend along substantially the entire length of the display device 300, and may couple to other drive electrode anchors within the display device 300. For example, the second suspended interconnect 320b may couple to every drive electrode anchor in a given row or column of display elements of the display device 300.

FIG. 3G shows a fourth cross-sectional view of the second example implementation of the display device 300 shown in FIG. 3A. The cross-section shown in FIG. 3G is taken along the line G-G′, which runs along the length of the second suspended interconnect 320b. As shown, the second suspended interconnect 320b is positioned at a greater height above the substrate 322 than the first suspended interconnect 320a. This allows the first suspended interconnect 320a to pass beneath the second suspended interconnect 320b.

A cross-sectional view of a pair of anchors 328a and 328b is shown. The anchors 328a and 328b are fixed to the rear substrate 322, and the second suspended interconnect 320b is supported between them. In some implementations, there may be additional circuitry formed directly on the rear substrate 322, as discussed above in connection with FIG. 3F. The second suspended interconnect 320b can carry electrical signals to this circuitry, for example, via the anchors 328a and 328b. For example, the anchors 328a and 328b can be coupled to a terminal of a transistor fabricated on (i.e., not suspended over) the rear substrate 322 associated with a respective display element. For example, in some implementations, the anchors 328a and 328b are coupled to the gates of transistors associated with the display elements. When a voltage is transmitted to one of the anchors 328a and 328b via the second suspended interconnect 320b, the voltage may cause the transistors to turn on, allowing actuation or data voltages to be transmitted to the display element. In some other implementations, the anchors 328a and 328b may be structural, and may not be electrically coupled to any of the display elements within the display device 300. Instead, they may serve to support the first suspended electrode above the rear substrate 322.

The implementations of the display device 300 shown in FIGS. 3A-3G include suspended interconnects 320a and 320b positioned at two different heights within the display device 300. In some implementations, the display device 300 can include suspended interconnects positioned at additional heights. For example, the display device 300 can include a third suspended interconnect positioned at a height below the height of the first suspended interconnect 320a or at a height above the second suspended interconnect 320b. In some implementations, a third suspended interconnect can be positioned at a height between the height of the first suspended interconnect 320a and the height of the second suspended interconnect 320b. In some implementations, the display device 300 can include more than three suspended interconnects positioned at any number of different heights.

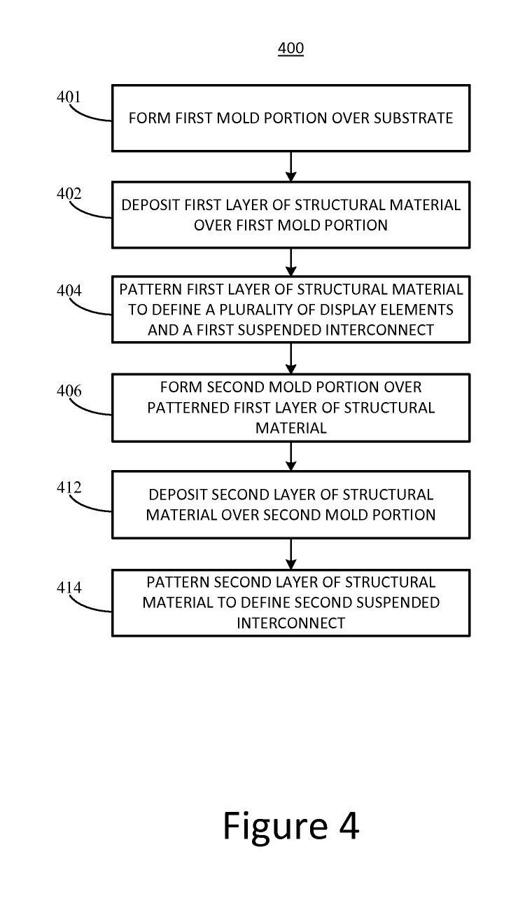

FIG. 4 shows a flow diagram of an example process 400 for manufacturing a display device including suspended interconnects. For example, the process 400 may be used to manufacture the display device 300 shown in FIGS. 3A-3C. In brief overview, the process 400 includes forming a first mold portion over a substrate (stage 401) and depositing a first layer of structural material over the first mold portion (stage 402). The first layer of structural material is patterned to define a plurality of display elements and a first suspended interconnect (stage 404). A second mold portion is formed over the patterned first layer of structural material (stage 406). A second layer of structural material is deposited over the second mold portion (stage 412). The second layer of structural material is patterned to define a second suspended interconnect (stage 414).

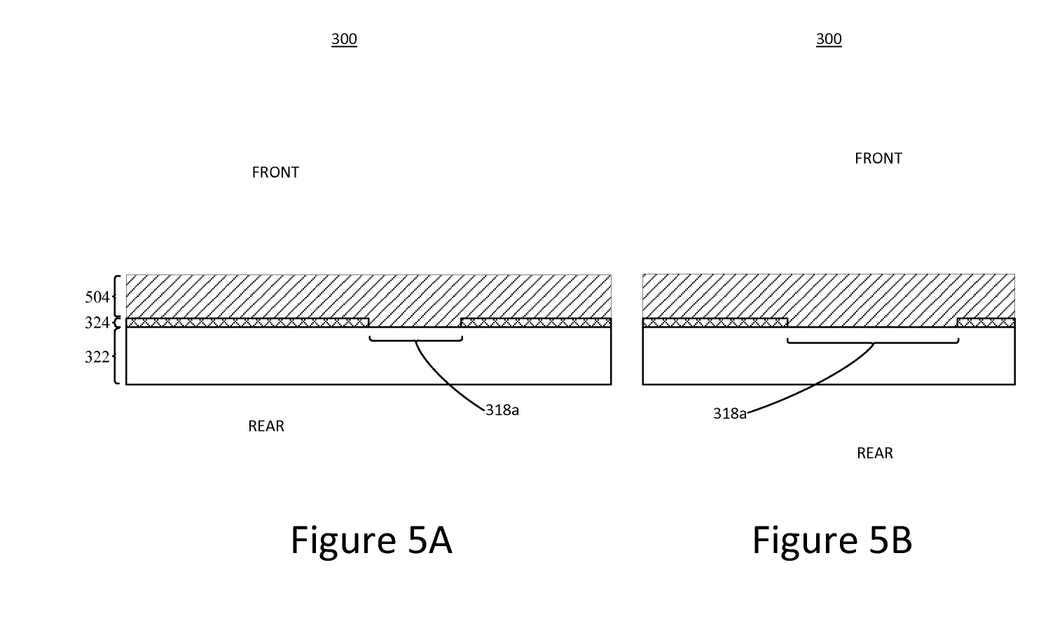

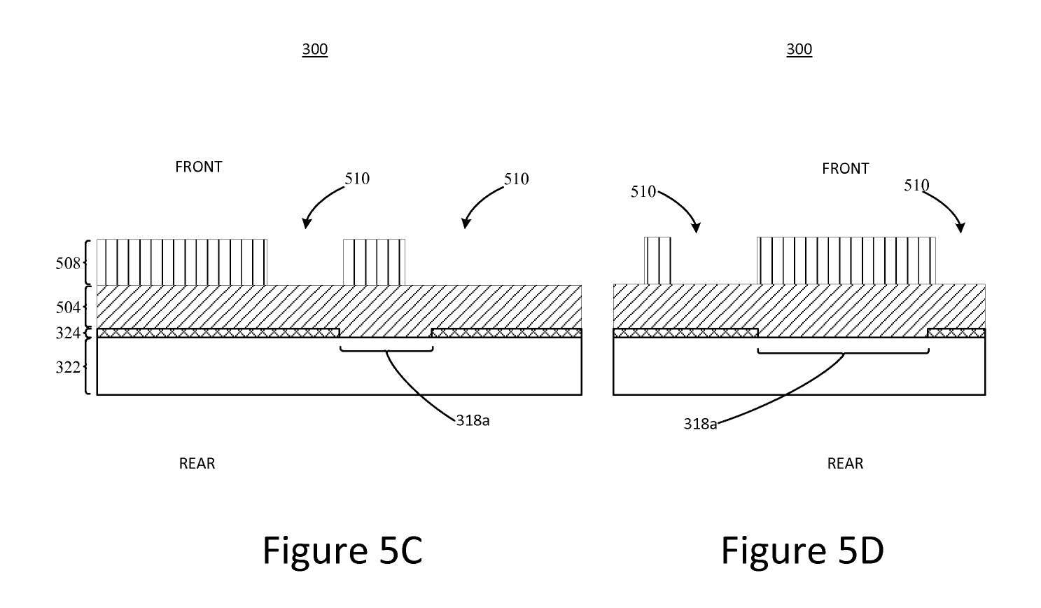

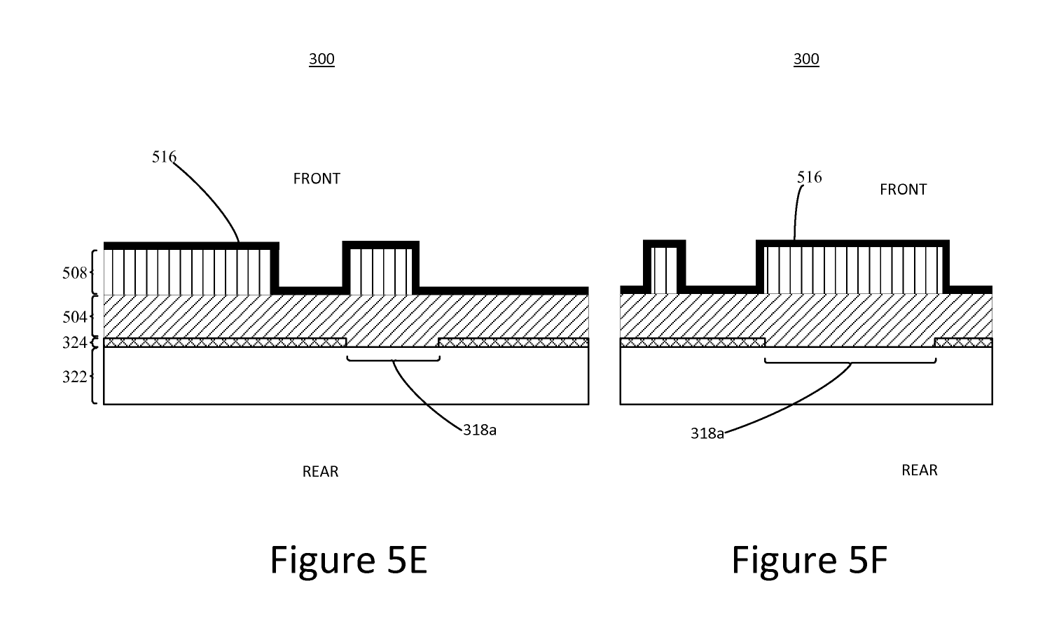

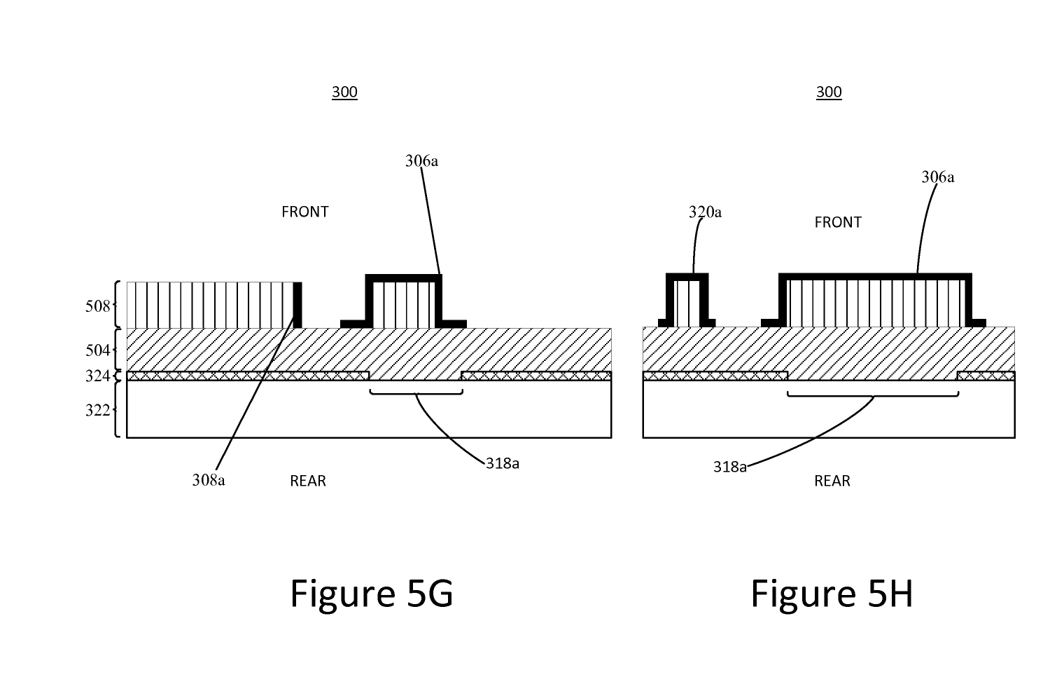

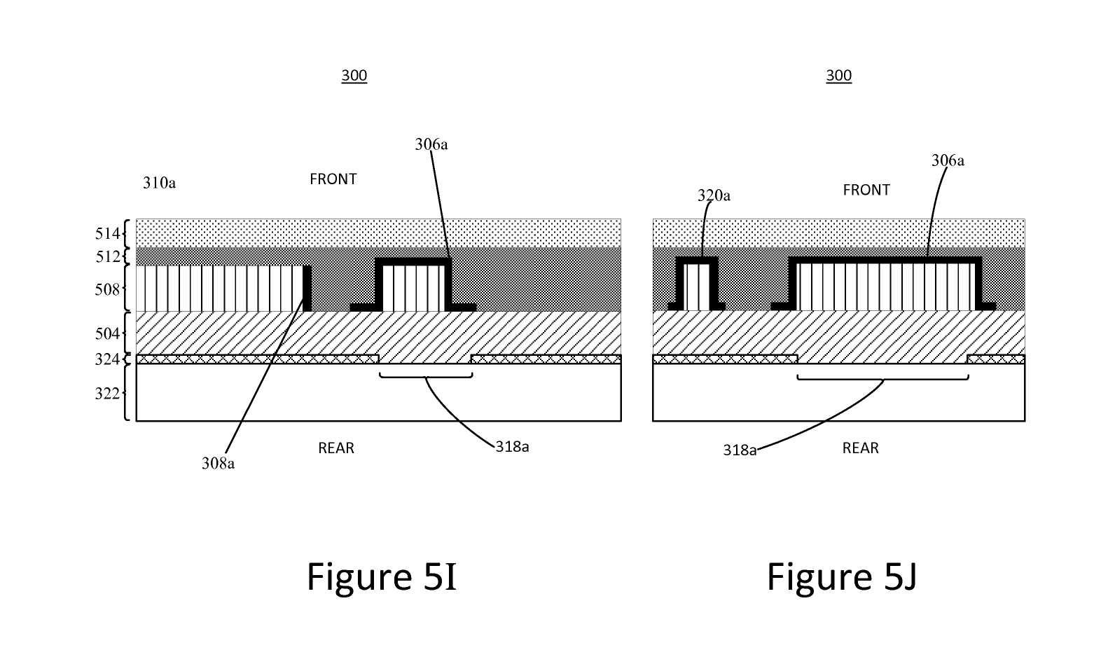

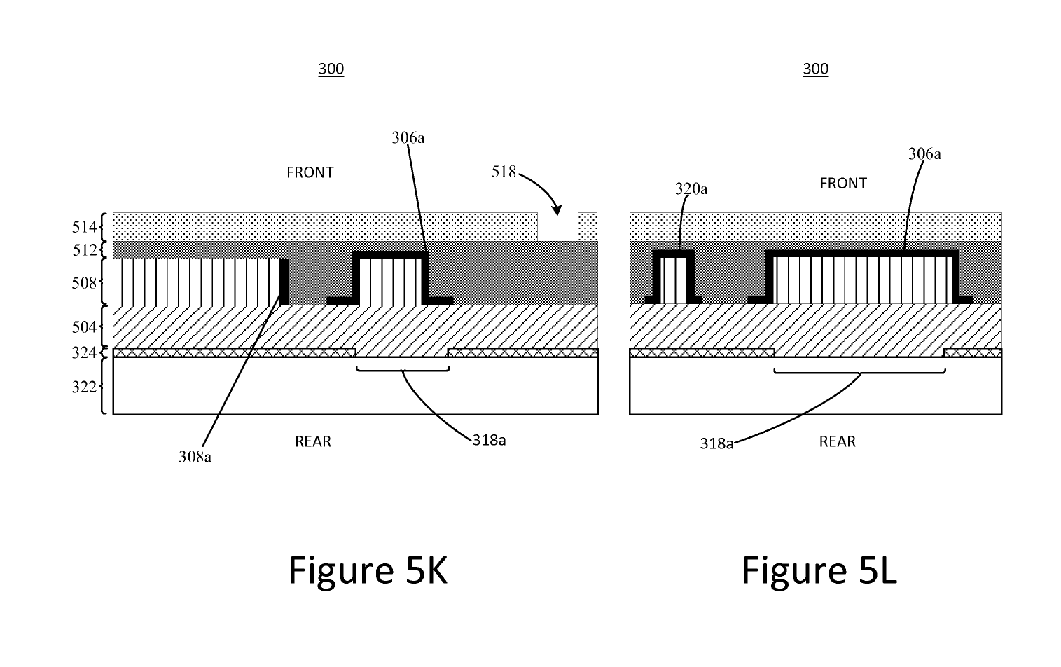

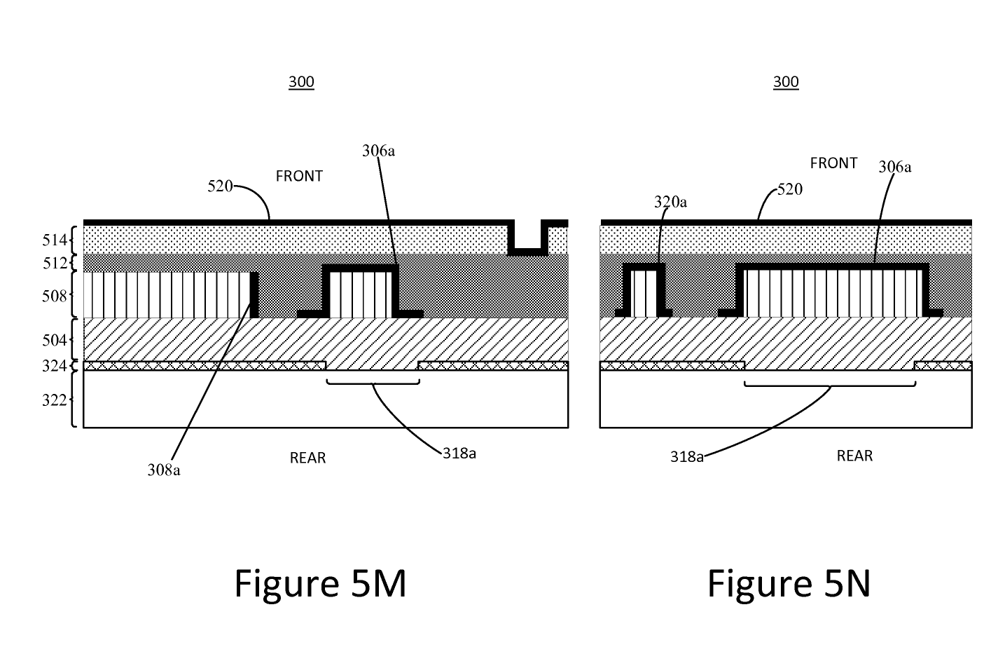

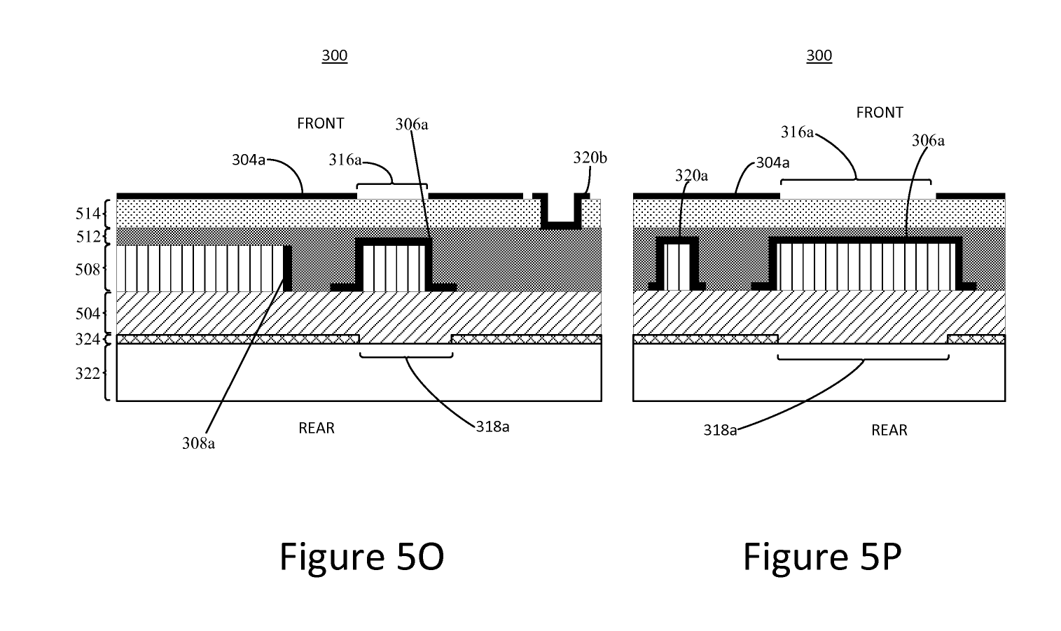

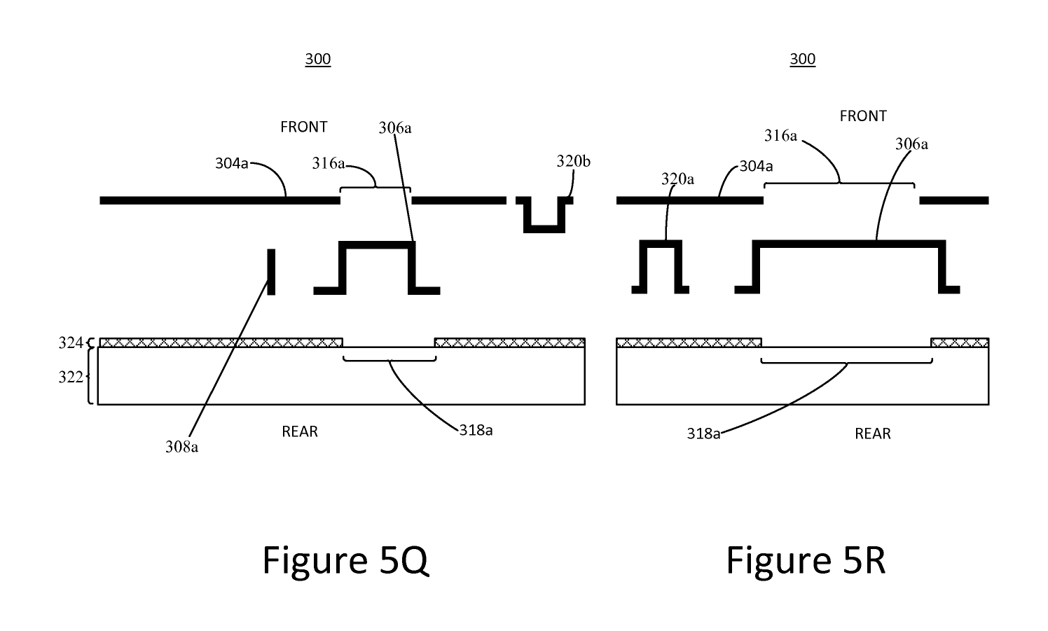

FIGS. 5A-5R show cross sectional views of example stages of construction of an example display device according to the manufacturing process shown in FIG. 4. The process 400 yields a display device formed on a substrate that includes first and second suspended interconnects. In the stages of construction shown in FIGS. 5A-5R, the display device is formed on mold portions made from sacrificial material.

The display device shown being constructed in FIGS. 5A-5R corresponds to the display device 300 shown in FIGS. 3A-3C. Like reference numerals refer to like elements. In particular, FIGS. 5A-5R show cross-sectional views along the lines B-B′ and C-C′ shown in FIG. 3A.

Referring to FIGS. 3A-3C, 4, and 5A-5R, the process 400 for forming the display device 300 includes, as shown in FIGS. 5A-5D, the formation of a first mold portion on top of a substrate (stage 401). The cross-sectional views of FIGS. 5A and 5C are taken along the line B-B′ shown in FIG. 3A and the cross-sectional views shown in FIGS. 5B and 5D are taken along the line C-C′ shown in FIG. 3A. The first mold portion is formed by depositing and patterning a first sacrificial material 504 on top of a light blocking layer 324 previously formed on an underlying substrate 322. The first layer of sacrificial material 504 can be or can include polyimide, polyamide, fluoropolymer, benzocyclobutene, polyphenylquinoxylene, parylene, polynorbornene, polyvinyl acetate, polyvinyl ethylene, and phenolic or novolac resins, or any of the other materials identified herein as suitable for use as a sacrificial material. Depending on the material selected for use as the first layer of sacrificial material 504, the first layer of sacrificial material 504 can be patterned using a variety of photolithographic techniques and processes such as by direct photo-patterning (for photosensitive sacrificial materials) or chemical or plasma etching through a mask formed from a photolithographically patterned resist. In some implementations, the first layer of sacrificial material 504 can be patterned to define recesses within which anchors, such as the load electrode anchor 310a, can be formed. Additional layers, including layers of material forming portions of a display control matrix may be deposited below the light blocking layer 324 or between the light blocking layer 324 and the first sacrificial material 504. In some implementations, additional layers of material may be deposited both below the light blocking layer 324 and between the light blocking layer 324 and the first sacrificial material 504. The light blocking layer 324 defines a rear aperture 318a. In some implementations, the aperture 318a is formed by a patterning or etching process that takes place prior to the deposition of the sacrificial material 504.

Formation of the first mold portion also can include the deposition of a second layer of sacrificial material 508 onto the first layer of sacrificial material 504. The second layer of sacrificial material 508 can be or can include any of the materials described above that may be suitable for use as the first layer of sacrificial material 504. The second layer of sacrificial material can then be patterned to form recesses 510, as shown in FIGS. 5C and 5D. The surfaces of the recesses 510 formed in the second layer of sacrificial material 508 can be used as a mold portion for the load electrode 308a, the shutter 306a, and the first suspended interconnect 320a over the substrate 322 shown in FIG. 3A.

The process 400 includes depositing a first layer of structural material 516 over the first mold portion (stage 402), the results of which are shown in FIGS. 5E and 5F. The cross-sectional view of FIG. 5E is taken along the line B-B′ shown in FIG. 3A and the cross-sectional view shown in FIG. 5F is taken along the line C-C′ shown in FIG. 3A. In some implementations, the first layer of structural material 516 is deposited in a chemical vapor deposition (CVD) process, a plasma-enhanced CVD (PECVD), or physical vapor deposition (PVD) process. The structural material 516 can include one or more layers including mechanical as well conductive layers. Suitable structural materials 516 include metals such as aluminum (Al), copper (Cu), nickel (Ni), chromium (Cr), molybdenum (Mo), titanium (Ti), tantalum (Ta), niobium (Nb), neodymium (Nd), or alloys thereof; dielectric materials such as aluminum oxide (Al₂O₃), silicon oxide (SiO₂), tantalum pentoxide (Ta₂O₅), or silicon nitride (Si₃N₄); or semiconducting materials such as diamond-like carbon, silicon (Si), germanium (Ge), gallium arsenide (GaAs), cadmium telluride (CdTe) or alloys thereof. In some implementations, the first layer of structural material 516 includes a stack of materials. For example, a layer of conductive structural material may be deposited between two non-conductive or semiconducting layers. In some implementations, a non-conductive or semiconducting layer is deposited between two conductive layers. In some implementations, such a “sandwich” structure helps to ensure that stresses remaining after deposition and stresses that are imposed by temperature variations will not cause bending, warping or other deformation of the structural material 516.

Furthermore, the inclusion of an electrically conductive material in the first layer of structural material 516 allows for the formation of the first suspended interconnect 320a that can be formed from the first layer of structural material 516. In some implementations, the first layer of structural material 516 also can include a protective layer to protect the structural material from damage during a release process in which the first layer of sacrificial material 504 and the second layer of sacrificial material 508 are removed. For example, the protective layer can include silicon nitride (SiN). The structural material 516 is deposited to a thickness of between about 0.5 microns and about two microns. In some implementations, the structural material 516 is deposited to have a thickness of less than about 1.5 microns.

After deposition, the first layer of structural material 516 (which may be a composite of several materials as described above) is patterned to define mechanical components of a plurality of display elements, including the display element 302a, and the first suspended interconnect 320a (stage 404). The results of this stage are shown in FIGS. 5G and 5H. The cross-sectional view of FIG. 5G is taken along the line B-B′ shown in FIG. 3A and the cross-sectional view shown in FIG. 5H is taken along the line C-C′ shown in FIG. 3A. A photoresist mask can be deposited on the first layer of structural material 516. The photoresist can then be patterned. The pattern developed into the photoresist is designed such that, after a subsequent etch stage, the remaining structural material 516 forms the shutter 306a, the load electrode 308a, and the first suspended interconnect 320a. The etch of the first layer of structural material 516 can be an isotropic etch or an anisotropic etch and can be carried out in a plasma atmosphere with a voltage bias applied to the substrate 322, or to an electrode in proximity to the substrate 322. In some implementations, the etch can be a combination of isotropic and anisotropic etches.

The process 400 includes forming a second mold portion over the patterned first layer of structural material. The results of these stages are shown in FIGS. 5I-5L. The cross-sectional views of FIGS. 5I and 5K are taken along the line B-B′ shown in FIG. 3A and the cross-sectional views shown in FIGS. 5J and 5L are taken along the line C-C′ shown in FIG. 3A. The second mold portion can be formed from a third layer of sacrificial material 512 and a fourth layer of sacrificial material 514. The third layer of sacrificial material 512 and the fourth layer of sacrificial material 514 can be or can include any of the sacrificial materials described above in connection with the first layer of sacrificial material 504 and the second layer of sacrificial material 508 that were used to form the first mold portion. In some implementations, the third layer of sacrificial material 512 material can be a planarizing layer that provides a substantially level surface on which the fourth layer of sacrificial material 514 can be deposited. The thickness of third layer of sacrificial material 514 defines the separation distance 360 between the first suspended interconnect 320a and the second suspended interconnect 320b that will be formed above the first suspended interconnect 320a. Accordingly, in some implementations the thickness of the third layer of sacrificial material 512 is selected to achieve a separation distance between the first suspended interconnect 320a and the second suspended interconnect 320b that results in a desired capacitance between the first suspended interconnect 320a and the second suspended interconnect 320b.

Forming the second mold portion can include patterning the third and fourth layers of sacrificial material. The third layer of sacrificial material 512 and the fourth layer of sacrificial material 514 can be patterned using any of the techniques discussed above in connection with the patterning of the first layer of sacrificial material 504 and the second layer of sacrificial material 508. The third and fourth layers of sacrificial material 512 and 514 can be patterned to form recesses 518. The surfaces of the recesses 518 will form a part of the mold portion for anchors that support the EAL 304a and a mold portion for the second suspended interconnect 320b. The fourth layer of sacrificial material 514 also can be patterned to provide additional topographical features, such as ribs, to the EAL 304a.

The process 400 includes depositing a second layer of structural material 520 over the second mold portion (stage 412). The results of this stage are shown in FIGS. 5M and 5N. The cross-sectional view of FIG. 5M is taken along the line B-B′ shown in FIG. 3A and the cross-sectional view shown in FIG. 5N is taken along the line C-C′ shown in FIG. 3A. The second layer of structural material 520 can include one or more layers including mechanical as well conductive layers. The materials selected for use as the second layer of structural material 520 can include any of the materials described above in connection with the first layer of structural material 516.

The process 400 includes patterning the second layer of structural material to define the second suspended interconnect 320b (stage 414). The results of this stage are shown in FIGS. 5O and 5P. The cross-sectional view of FIG. 5O is taken along the line B-B′ shown in FIG. 3A and the cross-sectional view shown in FIG. 5P is taken along the line C-C′ shown in FIG. 3A. A photoresist mask can be deposited and patterned on the second of structural material 520. The pattern developed into the photoresist is designed such that, after a subsequent etch stage, the remaining structural material 520 forms the second suspended interconnect 320b. In some implementations, the etch also can form the EAL 304a including the EAL aperture 316a. The EAL aperture 316a can be etched so that it is substantially aligned with the rear aperture 318a formed in the light blocking layer 324 deposited on the rear substrate 322. The etch of the second layer of structural material 520 can be an isotropic etch or an anisotropic etch and can carried out in a plasma atmosphere with a voltage bias applied to the substrate 322, or to an electrode in proximity to the substrate 322. In some implementations, the etch can be either an isotropic or an anisotropic etch, or a combination of isotropic and anisotropic etches.

In some implementations, the process 400 can include removing the first and second mold portions. The result, as shown in FIGS. 5Q and 5R, yields the display device 300 including the first suspended interconnect 320a and the second suspended interconnect 320b formed at different heights within the display device 300. The cross-sectional view of FIG. 5Q is taken along the line B-B′ shown in FIG. 3A and the cross-sectional view shown in FIG. 5R is taken along the line C-C′ shown in FIG. 3A. In some implementations, the first layer of sacrificial material 504 and the second layer of sacrificial material 508, together forming the first mold portion, as well as the third layer of sacrificial material 512 and the fourth layer of sacrificial material 514, together forming the second mold portion, are removed using standard MEMS release methodologies, including, for example, exposing the first and second mold portions to an oxygen plasma, wet chemical etching, or vapor phase etching.

The above description relates to display elements, EALs, and suspended interconnects formed over a rear substrate. In some other implementations, display elements, EALs and suspended interconnects can be formed on the rear-facing surface of a substrate that forms the front of the display device without departing from the scope of the disclosure.

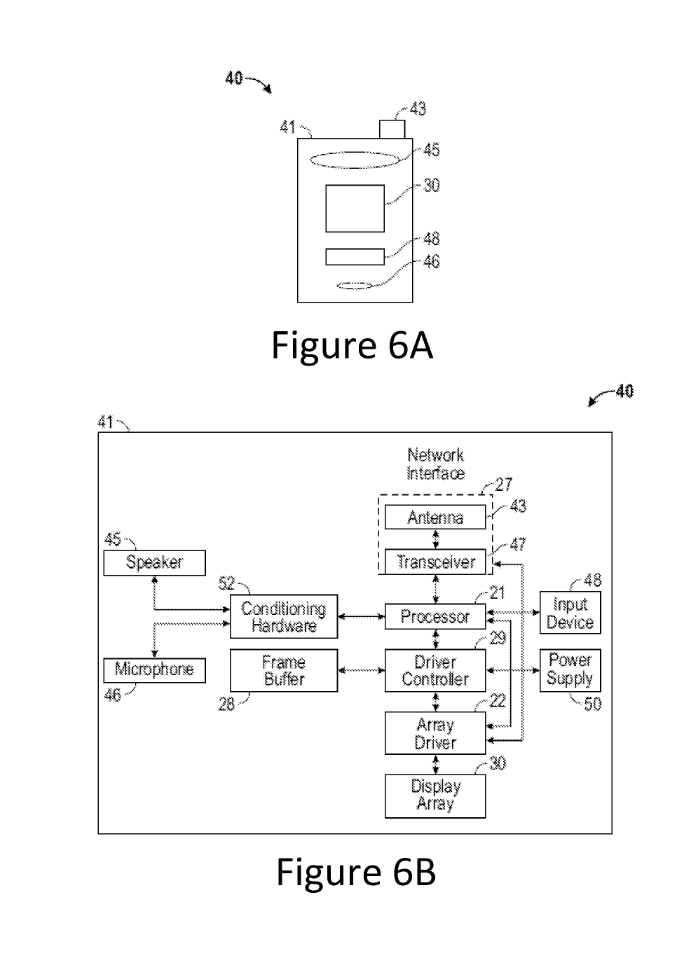

FIGS. 6A and 6B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 6B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display comprising:
a substrate;
a plurality of light modulators, each including a shutter suspended over the substrate;
a first suspended interconnect electrically coupling a first light modulator and a second light modulator of the plurality of light modulators, wherein more than 50% of a length of the first suspended interconnect is suspended at a first height over the substrate; and
a second suspended interconnect electrically coupling the first light modulator to a third light modulator of the plurality of light modulators, wherein more than 50% of a length of the second suspended interconnect is suspended at a second height, different from the first height, over the substrate.

2. The display of claim 1, wherein the first height is greater than the second height to allow the first suspended interconnect to pass over the second suspended interconnect.

3. The display of claim 1, further comprising an elevated aperture layer (EAL) suspended over the plurality of light modulators, wherein an uppermost surface of the first suspended interconnect is substantially coplanar with an uppermost surface of the elevated aperture layer.

4. The display of claim 1, wherein an uppermost surface of the second suspended interconnect is substantially coplanar with an uppermost surface of at least one light modulator shutter.

5. The display of claim 1, wherein the first suspended interconnect couples to anchors associated with the first and second light modulators.

6. The display of claim 1, wherein each of the first and second suspended interconnects include at least one of a structural layer, a conductive layer, a protective layer, and a passivation layer.

7. The display of claim 6, wherein the structural layer for at least one of the first and second suspended interconnects includes amorphous silicon (a-Si).

8. The display of claim 6, wherein the conductive layer for at least one of the first and second suspended interconnects includes an opaque metal.

9. The display of claim 1, wherein the first suspended interconnect serves as a data line for the display, and the second suspended interconnect serves as a scan line for the display.

10. The display of claim 1, wherein a first portion of the first suspended interconnect is oriented substantially parallel to the display, and a second portion of the first suspended interconnect is oriented substantially perpendicular to the display.

11. The display of claim 1, wherein a length of the first suspended interconnect is substantially perpendicular to a length of the second suspended interconnect.

12. The display of claim 1, wherein:
the first height of the first suspended interconnect and the second height of the second suspended interconnect reduce the capacitance between the respective suspended interconnects a backplane on the substrate.

13. The display of claim 1, further comprising:
a processor capable of communicating with the display, the processor being capable of processing image data; and
a memory device capable of communicating with the processor.

14. The display of claim 13, further comprising:
a driver circuit capable of sending at least one signal to the display; and
a controller capable of sending at least a portion of the image data to the driver circuit.

15. The display of claim 13, further comprising:
an image source module capable of sending the image data to the processor, wherein the image source module includes at least one of a receiver, transceiver, and transmitter.

16. The display of claim 13, further comprising:
an input device capable of receiving input data and communicating the input data to the processor.

17. A method of forming a display apparatus, comprising:
forming a first mold portion on a substrate;
depositing a first layer of structural material over the first mold portion;
patterning the first layer of structural material to define a plurality of MEMS light modulators and a first suspended interconnect;
forming a second mold portion over the patterned first layer of structural material;
depositing a second layer of structural material over the second mold portion; and
patterning the second layer of structural material to define a second suspended interconnect.

18. The method of claim 17, further comprising patterning the second layer of structural material to define an elevated aperture layer.

19. The method of claim 17, wherein:
the first layer of structural material includes a conductive material; and
the method further comprises depositing a layer of protective material over the conductive material.

20. The method of claim 17, further comprising coating the exposed surfaces of the plurality of light modulators, the first suspended interconnect, and the second suspended interconnect with a passivation material.

21. The method of claim 17, wherein a length of the first suspended interconnect is substantially perpendicular to a length of the second suspended interconnect.

22. A display comprising:
a substrate;
a plurality of light modulators, each including a shutter suspended over the substrate;
a first suspended interconnect electrically coupling a first light modulator and a second light modulator of the plurality of light modulators, wherein at least a portion of a length of the first suspended interconnect between the first light modulator and the second light modulator is suspended at a first height over the substrate; and
a second suspended interconnect electrically coupling the first light modulator to a third light modulator of the plurality of light modulators, wherein at least a portion of a length of the second suspended interconnect between the first light modulator and the third light modulator is suspended at a second height over the substrate, and wherein the first height is greater than the second height to allow the first suspended interconnect to pass over the second suspended interconnect.

23. The display of claim 22, further comprising an elevated aperture layer (EAL) suspended over the plurality of light modulators, wherein an uppermost surface of the first suspended interconnect is substantially coplanar with an uppermost surface of the elevated aperture layer.

24. The display of claim 22, wherein an uppermost surface of the second suspended interconnect is substantially coplanar with an uppermost surface of at least one light modulator shutter.

25. The display of claim 22, wherein the first suspended interconnect couples to anchors associated with the first and second light modulators.

26. The display of claim 22, wherein each of the first and second suspended interconnects include at least one of a structural layer, a conductive layer, a protective layer, and a passivation layer.

27. The display of claim 26, wherein the structural layer for at least one of the first and second suspended interconnects includes amorphous silicon (a-Si).

28. The display of claim 26, wherein the conductive layer for at least one of the first and second suspended interconnects includes an opaque metal.

29. The display of claim 22, wherein the first suspended interconnect serves as a data line for the display, and the second suspended interconnect serves as a scan line for the display.

30. The display of claim 22, wherein a first portion of the first suspended interconnect is oriented substantially parallel to the display, and a second portion of the first suspended interconnect is oriented substantially perpendicular to the display.
